(19) United States
(12) Patent Application Publication
(10) Pub. No.: US 2012/0300202 A1
(43) Pub. Date: Nov. 29, 2012

(54) AUTONOMOUS LIGHT AMPLIFYING DEVICE FOR SURFACE ENHANCED RAMAN SPECTROSCOPY

(76) Inventors: David A. Fattal, Mountain View, CA (US); Jingjing Li, Palo Alto, CA (US); Zhiyong Li, Redwood City, CA (US); Shih-Yuan Wang, Palo Alto, CA (US)

(21) Appl. No.: 13/383,385

(22) PCT Filed: Jul. 22, 2009
(86) PCT No.: PCT/US2009/051367

§ 371 Date: Jan. 10, 2012

(51) Int. Cl. G01J 3/44; B82Y 15/00

(52) U.S. Cl. 356/301; 977/774; 977/932

(57) ABSTRACT

An autonomous light amplifying device for surface enhanced Raman spectroscopy includes a dielectric layer, at least one laser cavity defined by at least one light confining mechanism formed in the dielectric layer, at least one nano-antenna established on the dielectric layer in proximity to the at least one laser cavity, and a gain region positioned in the dielectric layer or adjacent to the dielectric layer.

### BACKGROUND

The present disclosure relates generally to autonomous light amplifying devices for surface enhanced Raman spectroscopy.

Raman spectroscopy is used to study the transitions between molecular energy states when photons interact with a species, which results in the energy of the scattered photons being shifted. The Raman scattering of a species can be seen as two processes. The species, which is at a certain energy state, is first excited into another (either virtual or real) energy state by the incident photons, which is ordinarily in the optical frequency domain. The excited species then radiates as a dipole source under the influence of the environment in which it sits at a frequency that may be relatively low (i.e., Stokes scattering), or that may be relatively high (i.e., anti-Stokes scattering) compared to the excitation photons. The Raman spectrum of different species (e.g., molecules or matter) has characteristic peaks that can be used to identify such species. As such, Raman spectroscopy is a useful technique for a variety of chemical or biological sensing applications. However, the intrinsic Raman scattering process is often inefficient; and, as such, rough metal surfaces, various types of nano-antennas, as well as waveguiding structures have been used to enhance the Raman scattering processes (i.e., the excitation and/or radiation process described above). This field is generally known as surface enhanced Raman spectroscopy (SERS).

### BRIEF DESCRIPTION OF THE DRAWINGS

Features and advantages of embodiments of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a semi-schematic perspective view of an embodiment of an autonomous light amplifying device of the present disclosure;

FIGS. 2A and 2B are semi-schematic perspective views which together illustrate the formation of another embodiment of an autonomous light amplifying device of the present disclosure;

FIG. 3 is a semi-schematic perspective view of still another embodiment of an autonomous light amplifying device of the present disclosure;

FIGS. 4A and 4C are top views of an embodiment of the autonomous light amplifying device before and after a wet etching process used to form a suspended device;

FIG. 4B is a cross-sectional view, taken along line 4B-4B of FIG. 4A, of the embodiment of the autonomous light amplifying device before wet etching;

FIG. 4D is a is a cross-sectional view, taken along line 4D-4D of FIG. 4C, of the embodiment of the autonomous light amplifying device after wet etching (i.e., the suspended autonomous light amplifying device); and

FIG. 5 is a schematic diagram of an embodiment of a system including the light amplifying device(s) disclosed herein.

### DETAILED DESCRIPTION

Embodiments of the device disclosed herein advantageously include a gain region and a laser cavity formed in a dielectric layer. Together these components create a large local electric field for surface enhanced Raman spectroscopy without the use of an external light source. As such, the devices disclosed herein are autonomous (i.e., no external light source is used to excite a material of interest). More specifically, when the gain region is pumped with electrical or optical energy, random spontaneous emission of at least some photons occurs. The spontaneously emitted photons in combination with the energy supplied to the gain region results in the stimulated emission of additional photons. All of the generated photons are scattered via a light confining mechanism defining the laser cavity such that the photons propagate within and become trapped within the dielectric layer. The gain region amplifies the trapped photons, thereby enhancing the excitation, the local field, and the resulting Raman signal.

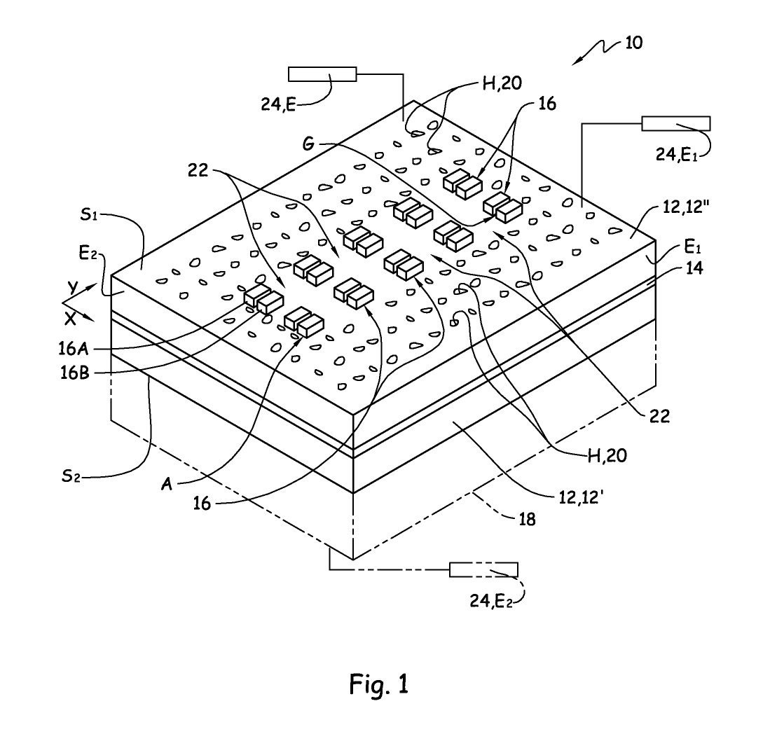

Referring now to FIG. 1, an embodiment of the autonomous light amplifying device 10 is depicted. The device 10 includes the dielectric layer 12 and gain region 14. In this embodiment, the dielectric layer 12 (or guiding layer) has two opposed surfaces S₁, S₂, one (S₁) of which has at least one nano-antenna 16 established thereon, and the other (S₂) of which is in contact with a substrate 18.

As shown in FIG. 1, the dielectric layer 12, having the gain region 14 embedded therein, is established on the substrate 18. It is to be understood that the substrate 18 is selected to have a refractive index that is less than the refractive index of the dielectric layer 12. Furthermore, it is to be understood that the substrate 18 is selected so that it does not absorb at the excitation or radiating frequencies of the device 10. Non-limiting examples of suitable substrate materials include insulators (e.g., glass, quartz, ceramic, alumina, silica, silicon nitride, etc.), polymeric material(s) (e.g., polycarbonate, polyamide, acrylics, etc.), or semiconductors (e.g., silicon, InP, GaAs, InAs, GaₓAl₁₋ₓAs (where 0<x<1), InₓGa₁₋ₓAs_{y}P_{1-y} (where 0<x<1, 0<y<1)), silicon-on-insulator (SOI) substrates, nitride-on-oxide substrates (e.g., silicon nitride on oxide), or group III-V semiconductors established on silicon or SOI substrates. As shown in some of the previous examples, the substrate 18 may include multiple layers. Other examples of multi-layered substrates include GaAs on AlGaAs or GaAs on Al₂O₃.

In the embodiment shown in FIG. 1, a portion 12′ of the dielectric layer 12 is grown or deposited directly on the substrate 18. Any suitable dielectric material may be used, and such dielectric materials are selected to have a higher refractive index than the refractive index of a material (e.g., the substrate 18) and/or environment (e.g., air) adjacent thereto. Non-limiting examples of suitable dielectric materials include III-V semiconductors, polymeric materials, or insulators. III-V semiconductor dielectric materials may be established via epitaxial growth; polymeric materials may be established via spin coating or other like deposition techniques; and insulators may be established via plasma enhanced chemical vapor deposition (PECVD), low pressure chemical vapor deposition (LPCVD), or other like deposition techniques. Other specific non-limiting examples of materials suitable for the dielectric layer 12 include silicon, gallium, arsenide, or indium phosphide.

In this embodiment, the material that makes up the gain region 14 is then grown or deposited on the portion 12′ of the dielectric layer 12. The material that makes up the gain region 14 may be any material that exhibits the desirable amplifying characteristics. In an example, the gain region 14 material is selected from a III-V semiconductor material (e.g., indium gallium arsenide) or erbium doped glass.

The gain region 14 may include quantum dots (e.g., in clusters or pyramids) or quantum wells. Quantum dots of a III-V semiconductor material may be grown epitaxially, or may be synthesized separately and spun on the portion 12′ in a resist-type material (non-limiting examples of which include polyimide, spin-on glass, photoresists, or the like). Quantum dots enable injected electrons and holes to recombine locally, thereby providing gain for the device 10. In an embodiment, the quantum dots have an average width ranging from about 10 nm to about 20 nm, and an average height up to about 3 nm. Quantum wells may be formed in semiconductors by having one material (e.g., gallium arsenide) sandwiched between two layers of a material with a wider bandgap (e.g., aluminum arsenide, indium arsenide, indium gallium arsenide, etc.). It is to be understood that the device 10 may include one or more quantum wells. Generally, the well material has a lower bandgap than the surrounding materials. In one embodiment, the gain region 14 includes a single well layer (where the substrate 18 and/or dielectric layer 12 form the higher bandgap materials), and in another embodiment, the gain region 14 includes multiple well layers (where materials other than the substrate and/or dielectric layer 12 form the higher bandgap materials). Electrons and holes may be injected into the device 10, and the quantum wells act as traps for both the electrons and holes. The recombination of the electrons and holes at the quantum wells provides the gain for the device 10. The quantum wells may be grown by molecular beam epitaxy or chemical vapor deposition. It is to be understood that during establishment of the gain region 14, the gases may be changed in order to achieve the desirable layers.

As shown in FIG. 1, once the gain region 14 is established, a second portion 12″ of the dielectric layer 12 is then grown or deposited thereon using the materials and techniques previously described. The total thickness of the dielectric layer 12 (including both portions 12′, 12″) is a fraction of the stimulating wavelength (i.e., the wavelength of the light generated and amplified by the device 10). The total thickness will depend, at least in part, on the desirable refractive index of the layer 12. Generally, a higher refractive index results in a thinner layer. In one example, the total thickness is about 200 nm, where each portion 12′, 12″ is about 100 nm thick.

In the embodiment shown in FIG. 1, the gain region 14 is included between portions 12′, 12″ of the dielectric layer 12. It is believed that this positioning maximizes the overlap of generated photons with the gain region 14.

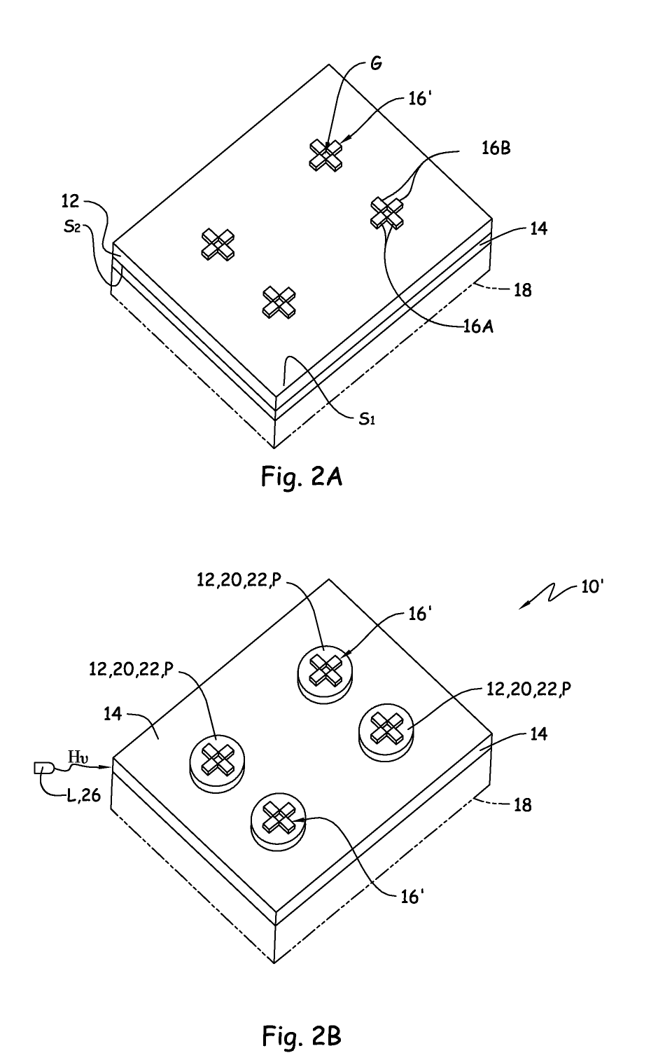

During or after growth of the portion 12″ of the dielectric layer 12, a light confining mechanism 20 is formed into the dielectric layer 12. The light confining mechanism 20 may be formed in the dielectric layer 12 in any suitable geometry that is capable of reflecting light such that it bounces around and stays confined within a cavity 22 defined by one or more of the light confining mechanisms 20. In an embodiment, the light confining mechanism 20 is configured to enable total internal reflection or Bragg reflection of the light. A light confining mechanism 20 configured to enable total internal reflection generally has a refractive index that is higher than that of the surrounding environment. As such, any light ray that strikes the boundary between the mechanism 20 and the surrounding environment at an angle larger than the critical angle with respect to the normal of the mechanism surface will be reflected back through the mechanism 20, and thus back through the dielectric layer 12. The micro-pillars P shown in FIG. 2B are one example of the light confining mechanism 20 that is capable of total internal reflection. Bragg reflection is the process in which light can be nearly totally reflected by a set of small holes/openings placed in another material in an ordered fashion. The photonic crystal holes H shown in FIG. 1 are one example of the light confining mechanism 20 that is capable of Bragg reflection.

As previously mentioned, the embodiment of FIG. 1 illustrates photonic crystal holes H as the light confining mechanism 20. In the example shown in FIG. 1, the photonic crystal holes H are arranged in a periodic fashion around the various nano-antennas 16. It is generally desirable that 2-15 rows of photonic crystal holes H are formed in the dielectric layer 12 along the X-axis or the Y-axis outward from each antenna 16. For example, in FIG. 1, moving from the nano-antenna labeled A along the X-axis toward the edge E1 of the portion 12″ of the dielectric layer 12, three rows of photonic crystal holes H are formed, and moving from the nano-antenna A along the Y-axis toward the edge E2 of the portion 12″ of the dielectric layer 12, two rows of photonic crystal holes H are formed. While 2 and 3 rows are shown in FIG. 1, in another embodiment, the number of photonic crystal hole row ranges from 5 to 10.

When photonic crystal holes H are used as the light confining mechanism 20, a laser cavity 22 is formed in the portion of the dielectric layer 12 surrounded by the photonic crystal holes H. As such, the holes H define the cavity 22 in the dielectric layer 12. It is to be understood that the cavity 22 has no light confining mechanism(s) 20 therein, and as described further herein, has one or more nano-antennas 16 established thereon. In the embodiment shown in FIG. 1, the photonic crystal holes H together act as an effective mirror to reflect light generated and amplified by the device 10, and cause the reflected light to become trapped laterally within the cavity 22. The geometry of the laser cavity 22 is selected so that the resulting amplified energy resonates at a desirable frequency and so the cavity 22 has a desirable electric field pattern. Such geometry is achieved by controlling the position of each photonic crystal holes H in the dielectric layer 12, 12″, and thus controlling the overall pattern of the holes H in the dielectric layer 12, 12″. While any suitable geometry may be used, the cavity 22 of FIG. 1 has a rectangular shape.

The photonic crystal holes H may be formed in the dielectric layer 12 via any suitable lithography technique (e.g., optical lithography, electron-beam lithography, nano-imprint lithography, etc.) followed by a dry etching technique commonly used in CMOS and III-V semiconductor processing. A non-limiting example of the dry etching includes Reactive Ion etching using fluorine, chlorine, and/or methane based gas(es). The photonic crystal holes H generally do not extend through the entire thickness of the dielectric layer portion 12″. In an embodiment in which the dielectric portion 12′ (or layer 12, as shown in FIG. 2) is 200 nm, the photonic crystal holes H have a depth of 50 nm or less. In one embodiment, all of the holes H have the same geometry.

Once the layers 12 and 14 are established and the laser cavity 22 is formed, the nano-antenna(s) 16 is/are established on the surface S₁ at a suitable position based upon the pattern of the photonic crystal holes H, and thus the geometry of the cavity 22. Generally, it is desirable to position the nano-antennas 16 close to (i.e., in proximity of) the maximum field region or another desirably high field region of the cavity 22. It is to be understood that the exact field pattern and the resonance frequency of the cavity 22 depend, at least in part, on the global geometry (i.e., size and shape) of the cavity 22. The field may be predicted using numerical methods, such as Finite Element Method (FEM) or Finite Difference Time Domain (FDTD). In one embodiment, each nano-antenna 16 is positioned on the cavity 22 at least about 200 nm away from the photonic crystal holes H.

It is to be understood that a single antenna 16 or multiple antennas 16 may be used in the device 10 disclosed herein. Each nano-antenna 16 established on the cavity 22 includes at least one dimension (e.g., ½ length (i.e., the length of one segment), width, height, etc.) that is on the nano-scale (e.g., from 1 nm to 200 nm). The nano-antenna 16 may have any suitable geometry, and often includes a gap G in which the material of interest to be studied via Raman spectroscopy is introduced. The embodiment of the nano-antenna 16 shown in FIG. 1 is a linear antenna (i.e., it extends in a single direction, with no curve or bend). The linear nano-antenna 16 includes two wire segments 16A, 16B having the gap G positioned therebetween. Such wire segments 16A, 16B (and thus optical antenna 16) are often made from plasmonic materials (e.g., noble metals such as gold and silver). It is to be understood that other nano-antenna 16 geometries may also be used. Non-limiting examples of such other geometries are cross antennas (shown in FIGS. 2A and 2B), bow-tie antennas, and elliptic, spherical, or faceted nanoparticle dimer antennas. The dimer antennas include two metallic particles that touch or have a small gap (e.g., less than 10 nm) therebetween. It is to be understood that the geometry of the antennas 16 may be altered such that it resonates at a desirable frequency.

The nano-antenna(s) 16 may be formed via a lithography technique (e.g., optical lithography, electron-beam lithography, nano-imprint lithography, photo-lithography, extreme ultraviolet lithography, x-ray lithography, etc.), or via a combination of deposition and etching techniques, or via a combination of deposition and lift-off techniques, or via direct deposition techniques (e.g., using focused ion beam (FIB) or plating). In one non-limiting example, the antenna(s) 16 are defined via a combination of lithography, metal evaporation, and lift-off techniques.

As shown in FIG. 1, one embodiment of the device 10 also includes an electrical pump 24. The electrical pump 24 includes a pair of contacts or electrodes E, E₁ or E, E₂ that are operatively connected to the device 10 in a manner sufficient to supply electrical energy to the gain region 14. As shown in FIG. 1, both electrodes E, E₁ may be in electrical communication with one portion 12′ of the dielectric layer 12, or one electrode E may be in electrical communication with the portion 12′ while the other electrode E₂ is in electrical communication with the substrate 18. One or both of the electrodes E, E₁, E₂ may be metal (e.g., gold, platinum, aluminum, silver, tungsten, copper, etc.). Although individual electrodes E, E₁ or E, E₂ are shown with rectangular cross-sections, electrodes E, E₁ or E, E₂ may also have circular, elliptical, or more complex cross-sections. The electrodes E, E₁ or E, E₂ may also have many different widths or diameters and aspect ratios or eccentricities. Furthermore, the electrodes E, E₁ or E, E₂ may be acquired in a usable state or may be fabricated using conventional techniques, such as photolithography or electron beam lithography, or by more advanced techniques, such as imprint lithography. In one embodiment, the thickness of each electrode E, E₁, E₂ ranges from about 5 nm to about 30 nm.

Metal electrodes E, E₂ may also be connected to highly doped semiconductors to form an ohmic contact (i.e., a contact with very low resistance). When a III-V semiconductor is used in conjunction with the metal electrode E, E₂ to form ohmic contacts, it is to be understood that any suitable dopant may be used during epitaxial growth to form the back contact (e.g., which is adjacent to both the substrate 18 and electrode E₂), or during ion implantation to form the top contact (e.g., which is adjacent to both the dielectric layer 12, 12′ and electrode E). It is to be understood that in this embodiment the interstitial semiconductors (e.g., those making up the dielectric layer 12 and/or the gain region 14) may also be doped.

In still another embodiment, electrical pumping into a III-V gain region 14 may be accomplished using a vertical p-n junction. For example, a highly p-doped region may be established on the surface S₁ and connected to metal vias, and the substrate 18 may be highly n-doped and connected to another metal contact. In this embodiment, the interstitial semiconductors (e.g., those making up the dielectric layer 12 and/or the gain region 14) may be slightly doped to decrease series resistance.

While the electrical pump 26 is shown in FIG. 1, it is to be understood that an optical pump 28 (shown and further described in reference to FIG. 2B) may be used to supply energy to the gain region 14.

When the device 10 is properly designed (including desirable laser cavity 22 and nano-antenna 16 geometries), light having a desirable frequency/angle is generated and amplified. During device 10 use, a material of interest (not shown) is placed in the gap G of the nano-antenna 16, and electrical energy is applied to the gain region 14 (which provides gain to the device 10). It is to be understood that the material of interest may also be placed at any other hot spot of the nano-antenna 16 (i.e., at a certain small area around the antenna 16 at which the electric field is believed to be stronger in a certain frequency range at or around the resonant frequency of the antenna 16). No external light source is used to excite the material; rather the electrically pumped gain region 14 generates random spontaneous emission of at least one photon. The photon(s), in combination with the energy being supplied to the gain region 14, stimulates the emission of additional photons in the dielectric layer 12. These photons propagate within the cavity 22 and are reflected off of the light confining mechanism 20. Such photons are essentially trapped within the cavity 22 portion of the dielectric layer 12, and thus light and a local electric field build up in the laser cavity 22.

This local electric field is suitable for Raman spectroscopy. More specifically, the energy generated by the electric field is amplified by the electrically activated gain region 14. In one embodiment, the frequency of the amplified energy corresponds with the resonance frequency of the nano-antennas 16, and thus the local field of the antenna(s) 16 is enhanced. The resulting SERS signal is then emitted at a frequency that is slightly shifted with respect to the resonance frequency.

It is believed that the device 10 may be configured with a second cavity mode so that the resulting SERS signal is amplified as well. In this embodiment, the geometry of at least a portion of the cavity 22 would be configured such that the frequency of the amplified energy corresponds with the frequency of the SERS signal, as opposed to the resonance frequency of the antennas 16. The cavity 22 may be simulated numerically, and the desirable geometry/geometries determined from this simulation.

As described in reference to the embodiment shown in FIG. 1, the nano-antennas 16 are formed after the formation of the photonic crystal holes H and the laser cavity 22. It is to be understood, however, that the nano-antennas 16 may be formed first, and then the photonic crystal holes H may be formed in a desirable pattern around the nano-antennas 16 to form the cavity 22.

FIGS. 2A and 2B together illustrate the formation of another embodiment of an autonomous light amplifying device 10′ (shown in FIG. 2B). In this embodiment, the gain region 14 is established on the substrate 18, and the dielectric layer 12 is established on the gain region 14. As such, the gain region 14 in this embodiment is positioned adjacent to the surface S₂, S₁ that is opposite to the surface S₁, S₂ upon which the nano-antenna 16 is established. As such, the gain region 14 is established between the substrate 18 and the dielectric layer 12, and is not sandwiched between portions 12′, 12″ of the dielectric layer 12.

Any suitable dielectric material may be used, and such dielectric materials are selected to have a higher refractive index than the refractive index of a material (e.g., the substrate 18) and/or environment (e.g., air) adjacent thereto. It is to be understood that the dielectric layer 12 may be any of the materials described herein in reference to FIG. 1.

In this embodiment, both the gain region 14 and the substrate 18 are selected to have a refractive index that is less than the refractive index of the dielectric layer 12. The substrate 18 is also selected so that it does not absorb at the excitation or radiating frequencies of the device 10′. Examples of suitable substrate materials and gain region materials are described in reference to FIG. 1.

In this embodiment, the material that makes up the gain region 14 is grown or deposited on the substrate 18. The material that makes up the gain region 14 may be any of those described herein. Similar to the embodiment described in FIG. 1, the gain region 14 may include quantum dots (e.g., in clusters or pyramids) or quantum wells. Any of the methods and/or materials disclosed herein for the quantum dot or quantum wells may be utilized in this embodiment as well.

As shown in FIG. 2A, once the gain region 14 is established, the dielectric layer 12 is then grown or deposited thereon using the materials and techniques previously described.

The nano-antenna(s) 16′ is/are then established on the surface S₁ using the materials and methods described herein. The nano-antennas 16′ in this embodiment are positioned so that each one is positioned on and corresponds with a subsequently formed light confining mechanism 20 (shown in FIG. 2B). Also in this embodiment, each nano-antenna 16′ includes two linear antennas (each of which includes two segments 16A and 16B) that cross at a non-zero angle and share a gap G (suitable for receiving the material of interest) at their intersection. It is to be understood that other nano-antenna(s) designs may also be used in this embodiment of the device 10″.

During or after growth of the dielectric layer 12, the light confining mechanism 20 is formed from/in the dielectric layer 12. The embodiment of FIG. 2B illustrates micro-pillars P as the light confining mechanisms 20. Such micro-pillars P may be formed in the dielectric layer 12 via any suitable lithography technique (e.g., optical lithography, electron-beam lithography, nano-imprint lithography, etc.) followed by a dry etching technique commonly used in CMOS and III-V semiconductor processing. A non-limiting example of the dry etching includes Reactive Ion etching using fluorine, chlorine, and/or methane based gas(es). As shown in FIG. 2B, the micro-pillars P are formed such that a respective nano-antenna 16′ is established on a respective micro-pillar P. It is to be understood that each micro-pillar P also functions as the cavity 22. As such, in the embodiment of FIG. 2B, multiple laser cavities 22 are formed in/from the dielectric layer 12.

The micro-pillar P light confining mechanisms 20 are configured to enable total internal reflection because the refractive index of the dielectric layer 12 from which they are formed is higher than that of the surrounding environment. As such, any light ray that strikes the boundary between the micro-pillar P and the surrounding environment at an angle larger than the critical angle with respect to the normal of the micro-pillar P surface will be reflected back through the micro-pillar P. This internal reflection enables the light to build up within the cavity 22.

Each micro-pillar P includes at least one dimension (e.g., width, height, etc.) that is on the micron-scale (e.g., from 0.5 microns to 200 microns). The height of the respective micro-pillars P will depend, at least in part, upon the thickness of the layers 12 and/or 14 from which it is formed, and the width of the respective micro-pillars P will depend, at least in part, upon the dimensions of the nano-antenna 16 to be formed thereon. Generally, the global geometry (i.e., size and shape) of the micro-pillars P is selected so that a desirable field pattern and a desirable resonance frequency are achieved.

Generally, the respective cavities 22 are positioned at some desirable spaced distance from each of the other cavities 22. In one embodiment, the distance (e.g., greater than 200 nm) is such that each micro-pillar P functions as a separate cavity 22. In another embodiment, the spacing between the cavities 22 may be selected so that the cavities 22 are coupled. Such coupling allows the photons/light that are not internally reflected within one laser cavity 22 to bounce into another laser cavity 22 (e.g., an adjacent cavity 22), thereby advantageously contributing to the electric filed build up in the other cavity 22. When it is desirable to couple the cavities 22, the distance by which adjacent cavities 22 are separated is equal to or less than 200 nm, and may range from about 100 nm to 200 nm.

Also as shown in FIG. 2B, one embodiment of the device 10′ includes an optical pump 26. The optical pump 26 includes at least one light source L that is operatively positioned relative to the device 10′ in a manner sufficient to supply optical energy to the gain region 14. As shown in FIG. 2, the light source L is in optical communication with one area of the gain region 14. It is to be understood that multiple light sources L may be used to supply energy to the gain region 14, and that such additional light sources (not shown) may be positioned such that light is directed toward other areas of the gain region 14. Non-limiting examples of the light source L include a light-emitting diode (LED) or a laser, the frequency of which depends upon the gain region 14 used. As one example, erbium doped glass is pumped at 980 nm or 1,480 nm, and exhibits gain in the 1,550 nm region.

When the device 10′ is properly designed (including desirable laser cavity 22 and nano-antenna 16 geometries), light having a desirable frequency/angle is generated and amplified. During use of device 10′, a material of interest is placed in the gap G (or another hot spot) of the nano-antenna 16′. Optical energy is applied to the gain region 14 (which provides gain to the device 10), but is not directly used to excite the material. Rather, the optically pumped gain region 14 generates random spontaneous emission of at least one photon. The photon(s), in combination with the energy being supplied to the gain region 14, stimulates the emission of additional photons in the respective cavities 22. These photons propagate within the cavities 22. Such photons are essentially trapped within the respective cavities 22, and thus a local electric field builds up within each of the laser cavities 22.

This local electric field is suitable for Raman spectroscopy. More specifically, the energy generated by the electric field is amplified by the optically activated gain region 14. In one embodiment, the frequency of the amplified energy corresponds with the resonance frequency of the nano-antennas 16′, and thus the local field of the antenna(s) 16′ is enhanced. The resulting SERS signal is then emitted at a frequency that is slightly shifted with respect to the resonance frequency.

When the micro-pillars P are configured to function as independent cavities 22, the frequency at which such pillars P are amplifying energy may be different from pillar P to pillar P. For example, the resonance frequencies of two of the nano-antennas 16′ may be different, and the geometry of the corresponding micro-pillar P may be configured so that the amplified light is at the respective resonance frequency. However, when the micro-pillars P are coupled to each other (e.g., to form a phase array), it is desirable that they be configured to amplify energy at the same frequency.

The embodiment shown in FIGS. 2A and 2B has the nano-antennas 16′ formed prior to formation of the micro-pillars P. It is to be understood, however, that the micro-pillars P may be formed first, and then the nano-antennas 16′ may be formed thereon.

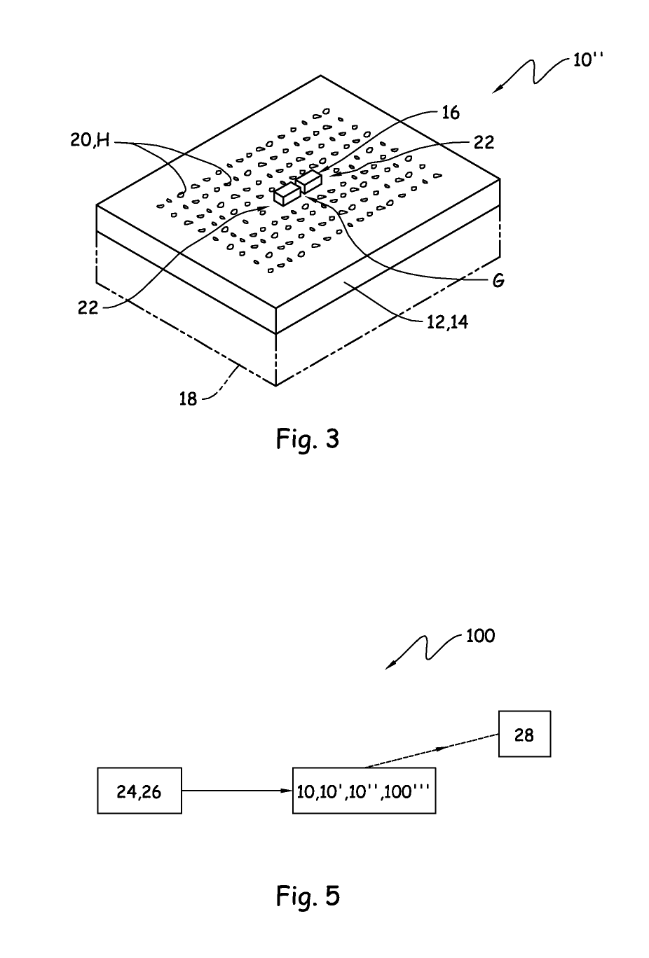

Referring now to FIG. 3, still another embodiment of the device 10″ is depicted. Similar elements and components to those described in reference to FIGS. 1 and 2 are included in the device 10″ of FIG. 3, and thus the materials and techniques described in connection with such devices 10, 10′ are suitable for the device 10″ shown in FIG. 3. While the electrical and/or optical pump 24, 26 is not shown in FIG. 3, it is to be understood that either of such pumps 24, 26 may be used to supply energy to the gain region 14.

In the embodiment of the device 10″ shown in FIG. 3, the gain region 14 is formed in all or a portion of the dielectric layer 12. The material selected for the gain region 14 may be implanted into the dielectric layer by ion implantation. One non-limiting example of this embodiment is erbium ions introduced into a glass layer. It is to be understood that the voltage used during ion implantation may be controlled in order to control the depth at which the ions are implanted into the dielectric layer 14. In some instances, the ions may be implanted into the entire depth of the dielectric layer 12, and thus the gain region 14 is present throughout the dielectric layer 12. In other instances, the ions may be implanted into a portion of the depth of the dielectric layer 12, and thus the gain region 14 is present in that portion of the dielectric layer 12. Also in the embodiment of FIG. 3, the light confining mechanisms 20, and the cavity 20 defined thereby, are formed in both the dielectric layer 12 and the gain region 14.

It is to be understood that any of the configurations of the laser cavities 22 and/or antennas 16, 16′ may be used in any of the embodiments of the device 10, 10′, 10″, 10′″ disclosed herein. For example, the configuration of the dielectric layer 12 and gain region 14 of FIG. 1 may be used with the multiple laser cavities 22 and nano-antennas 16′ shown in FIG. 2. It is to be understood that if the micro-pillars P are formed in the embodiment in which the gain region 14 is sandwiched between the two portions 12′, 12″ of the dielectric layer 12, the pillars P may be formed through each of the layers/portions 12′, 14, 12″ or in the portion 12″ of the dielectric layer 12. When the pillars P are formed in each layer/portion 12′, 14′, 12″, it is believed that since the pillars P are relatively large (compared, e.g., to the nano-antennas 16, 16′), any recombination of carriers at the sidewalls of such pillars P will not deleteriously affect the performance of the device 10, 10′, 10″, 10′″.

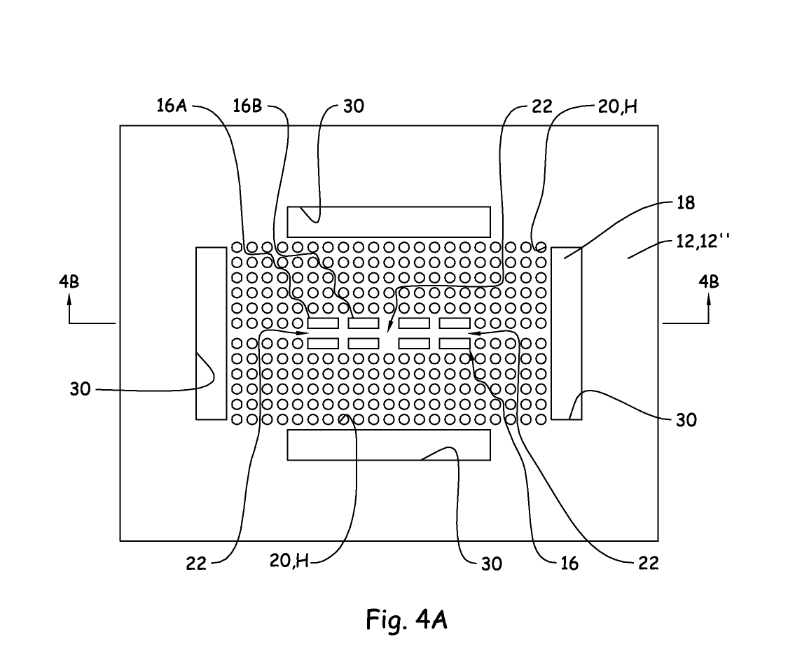

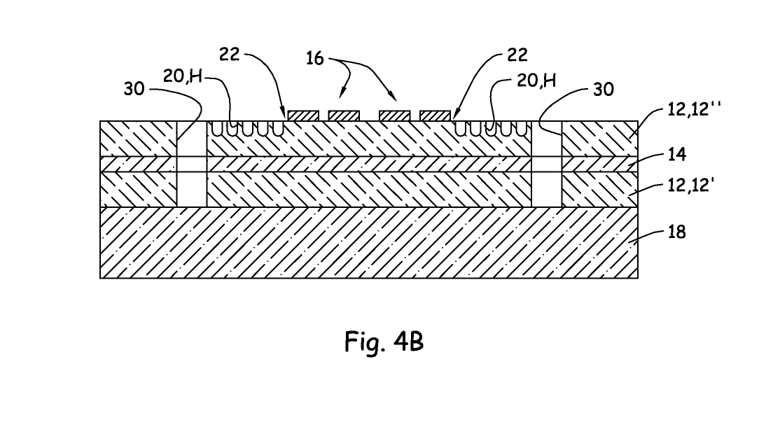

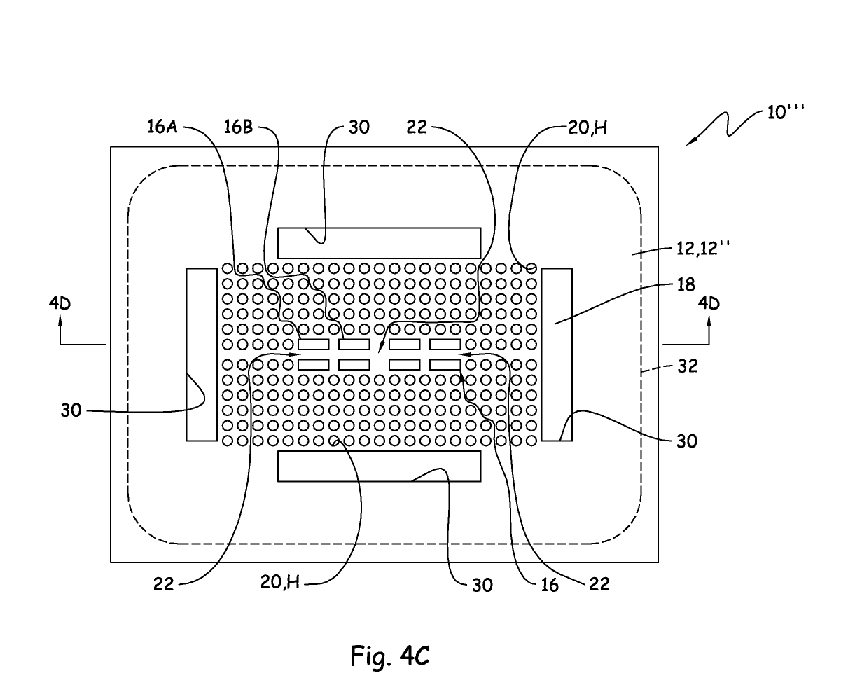

It is to be further understood that the components 12, 14, 16 or 16′, and 20 may not be established on the entire substrate 18, but rather may be suspended over the substrate 18. This is shown in FIG. 4D. Together, FIGS. 4A and 4C or FIGS. 4B and 4D illustrate the formation of such a device 10″. The embodiment shown in FIGS. 4A and 4B is similar to the device 10 shown in FIG. 1, except that the photonic crystal holes H are formed in rows of 5. It is to be understood that the photonic crystal holes H may, in some instances, have the same X and Y periodicity.

Furthermore, in this embodiment, openings 30 are formed through the entire depth of the dielectric layer 12 to expose the substrate 18. Such openings 30 may surround the components 12, 14, 16, 20. These openings 30 may be formed in a similar manner to that used for photonic crystal holes H, for example, via some form of lithography followed by dry or wet etching.

After the openings 30 are formed, an etchant that selectively etches the substrate 18, and not the dielectric layer 12 or the gain region 14, is exposed to the substrate 18 through the openings 30. This etchant removes a portion of the substrate 18. Etching the substrate 18 in such a manner results in the light confining mechanisms 20 (in this embodiment, the photonic crystal holes H), the nano-antennas 16, and layers 12 and 14 (upon which such components 16, 20 are formed or established) being suspended over a void 32 formed in the substrate 18. The time for which the substrate 18 is exposed to the etchant will dictate how much of the substrate 18 is removed. Generally, the etching time depends upon the concentration and the type of etchant used. In one embodiment the etching time is less than or equal to 5 minutes. It is believed that the etchant will etch away at the substrate 18 equally in the lateral directions. As such, in some instances, the amount of substrate 18 removed to the left of one opening 30 is equal to the amount of substrate removed to the right of the same opening 30. In a non-limiting example, when the dielectric layer 12 is GaAs and the substrate 18 is AlGaAs, hydrofluoric acid (HF) may be a suitable etchant. The resulting suspended device 10′″ is shown in FIGS. 4C (top view) and 4D (cross-sectional view).

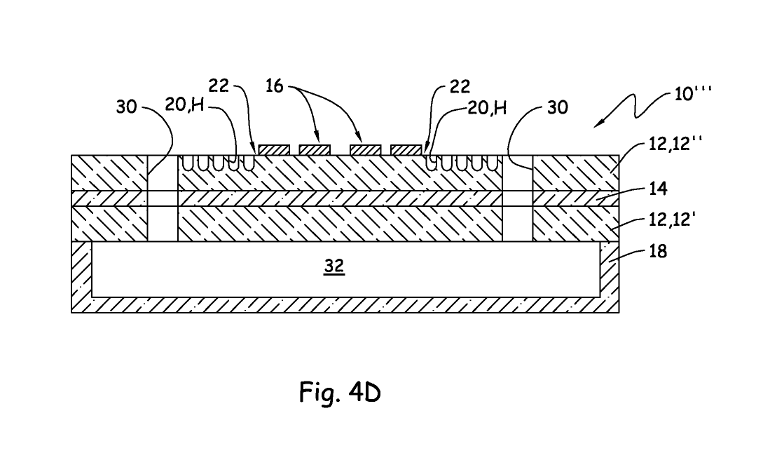

The devices 10, 10′, 10″, 10″ disclosed herein are suitable for use in standard Raman detection procedures, except that an external light source for stimulating the material of interest is not needed. The system 100 for such a procedure is shown schematically in FIG. 5 and includes the device 10, 10′, 10″, 10′″, the electrical or optical pump 24, 26, and a detector 28. In some embodiments, analyte molecules or particles are distributed in the gap or at the hot spot of the nano-antenna(s) 16, 16′ and are subsequently stimulated/excited via energy generated and amplified by the device 10, 10′, 10″, 10′″. As previously mentioned, the spontaneously emitted photons, in combination with the pumped energy, generate additional photons which become trapped within the cavity/cavities 22. The trapped light is amplified by the gain layer 14. This amplified light excites the molecule(s)/particle(s) in or on the nano-antenna 16, 16′ and the resulting Raman signals are detected using known detector(s) 28.

While several embodiments have been described in detail, it will be apparent to those skilled in the art that the disclosed embodiments may be modified. Therefore, the foregoing description is to be considered exemplary rather than limiting.

1-15. (canceled)

16. An autonomous light amplifying device for surface enhanced Raman spectroscopy, the device comprising:
a dielectric layer;
at least one laser cavity defined by at least one light confining mechanism formed in the dielectric layer;
at least one nano-antenna established on the dielectric layer in proximity to the at least one laser cavity; and
a gain region positioned in the dielectric layer or adjacent to the dielectric layer.

17. The autonomous light amplifying device as defined in claim 16, further comprising an energy source selected from i) a pair of electrodes and ii) a light source, the energy source operatively configured to supply energy to the gain region.

18. The autonomous light amplifying device as defined in claim 17 wherein the gain region is configured to spontaneously emit at least one photon which, in combination with the energy supplied to the gain region, stimulates additional photon generation, and wherein a resulting electric field is configured to build up in the laser cavity.

19. The autonomous light amplifying device as defined in claim 18, further comprising a material of interest positioned adjacent to the at least one nano-antenna, wherein the resulting electric field is configured to provide excitation energy for the material.

20. The autonomous light amplifying device as defined in claim 18 wherein the resulting electric field generates energy having a predetermined frequency, and wherein the predetermined frequency is dependent upon a predetermined geometry of the laser cavity.

21. The autonomous light amplifying device as defined in claim 20 wherein the predetermined frequency corresponds with a resonance of the at least one nano-antenna.

22. The autonomous light amplifying device as defined in claim 16 wherein a refractive index of the dielectric layer is higher than a refractive index of a material or environment directly adjacent thereto.

23. The autonomous light amplifying device as defined in claim 16 wherein the gain region includes at least one of quantum dots or quantum wells.

24. The autonomous light amplifying device as defined in claim 16 wherein the light confining mechanism is selected from a plurality of photonic crystal holes and at least one micro-pillar.

25. The autonomous light amplifying device as defined in claim 16, further comprising:
at least one other laser cavity defined by at least one other light confining mechanism formed in the dielectric layer, the at least one other laser cavity being a spaced distance from the at least one laser cavity; and
at least one other nano-antenna established on the dielectric layer in proximity to the at least one other laser cavity.

26. The autonomous light amplifying device as defined in claim 16, further comprising a substrate having the dielectric layer established directly or indirectly thereon, wherein the substrate has a refractive index that is less than the refractive index of the dielectric layer.

27. The autonomous light amplifying device as defined in claim 26 wherein the gain region is positioned between two portions of the dielectric layer, and wherein one portion of the dielectric layer is established directly on the substrate.

28. The autonomous light amplifying device as defined in claim 26 wherein the gain region is established directly on the substrate, and wherein one of two opposed surfaces of the dielectric layer is established on the gain region.

29. The autonomous light amplifying device as defined in claim 26 wherein at least a portion of the dielectric layer, the at least one laser cavity, and the at least one nano-antenna are suspended over the substrate.

30. A system for performing surface enhanced Raman spectroscopy, comprising:
an autonomous light amplifying device for surface enhanced Raman spectroscopy, the device including:
a dielectric layer;
at least one laser cavity defined by at least one light confining mechanism formed in the dielectric layer;
at least one nano-antenna established on the dielectric layer in proximity to the at least one laser cavity; and
a gain region positioned in the dielectric layer or adjacent to the dielectric layer; and
an energy source operatively configured to supply energy to the gain region of the autonomous light amplifying device.

31. The system as defined in claim 30, further comprising a detector operatively positioned to detect a Raman signal from a material of interest positioned adjacent to at least a portion of the at least one nano-antenna of the autonomous light amplifying device after the material is excited via a nano-antenna local field which is enhanced by light built up in the laser cavity as a result of spontaneous emissions from the gain region and emissions amplified via the gain region.

32. A method for making an autonomous light amplifying device for surface enhanced Raman spectroscopy, the method comprising:
forming, in a dielectric layer in a predetermined manner, at least one light confining mechanism, thereby forming a laser cavity;
establishing at least one nano-antenna on the dielectric layer in proximity to the at least one laser cavity;
forming a gain region in the dielectric layer or adjacent to the dielectric layer; and
operatively positioning an energy source such that it is selectively configured to supply energy to the gain region.

33. The method as defined in claim 32, further comprising configuring a geometry of the laser cavity such that an electric field built up in the laser cavity generates energy having a predetermined frequency.

34. The method as defined in claim 32, further comprising configuring the geometry of the laser cavity such that the predetermined frequency corresponds with a resonance frequency of the at least one nano-antenna.

35. The method as defined in claim 32 wherein the forming of the at least one light confining mechanism in the dielectric layer is accomplished via a lithography technique followed by a dry etching technique.
